(19) United States
(12) Patent Application Publication
(10) Pub. No.: US 2010/0032035 A1
(43) Pub. Date: Feb. 11, 2010

(54) SAFETY VALVE SYSTEM

(76) Inventor: Jerry Hedrick, Mt. Carmel, IL (US)

Correspondence Address: JAY M. SCHLOFF, 6960 Orchard Lake Road, Suite 315, West Bloomfield, MI, 48322, US

(21) Appl. No.: 12/537,449

(22) Filed: Aug. 7, 2009

Related U.S. Application Data
(60) Provisional application No. 61/087,317, filed on Aug. 8, 2008.

(51) Int. Cl. F16K 31/48; F16K 21/04

(52) U.S. Cl. 137/624.11

(57) ABSTRACT

A safety valve system for regulating supply of water through a water supply line. The safety valve system includes a shut-off valve coupled with the water supply line, a flow indicator communicably coupled to the shut-off valve and a control panel communicably coupled to the flow indicator. The shut-off valve is configured to assume one of an open position and a closed position. The flow indicator includes a timer capable of being activated for a pre-determined time when the water starts flowing through the water supply line. The control panel is configured to control at least one of the timer and the shut-off valve. Further, the open position of the shut-off valve allows the water to flow through the water supply line and the closed position stops the flow of the water on elapsing of the pre-determined time, thereby regulating the supply of the water through the water supply line.

### CROSS REFERENCE TO RELATED APPLICATIONS

The present disclosure claims priority under 35 United States Code, Section 119 on the U.S. Provisional Patent Application No. 61/087,317 filed on Aug. 8, 2008, the disclosure of which is incorporated by reference.

### FIELD OF THE DISCLOSURE

The present disclosure relates generally to a plumbing system for fluid control, and, more particularly, to a safety valve system for regulating supply of water through a water supply line.

### BACKGROUND OF THE DISCLOSURE

Most buildings, such as apartments, houses, office complexes, and the like, are provided with water from a central water source. The water received from the central water source is typically distributed into the buildings through a main water supply line. Thereafter, the water may be provided inside the buildings through various plumbing fixtures, such as faucets, water valves, and the like, for distributing the water. Such plumbing fixtures may be controlled by a user based on his/her water usage requirements.

Typically, a rupture may occur in any part of the water supply line or in the plumbing fixtures. It may be difficult to identify a location of the rupture in the water supply line and in the plumbing fixtures. Further, sometimes occupants of a building, such as a house, may leave their home unattended for hours, days or weeks at a stretch. In such a scenario, a rupture in any of the plumbing fixtures or in the water supply line of the building may lead to tremendous wasting of water. Alternatively, the occupants may forget to close the plumbing fixtures before leaving their homes, causing wasting of water and an increased water bill.

Further, a continuous flow of the water may cause a portion of the building to be flooded. The flooding, in turn, may cause furniture, equipment, and expensive appliances to be damaged. Also, internal structures, such as floor, walls and ceilings, of the building may also be damaged as a result. Such damage may increase costs and inconvenience for the occupants.

In light of the drawbacks mentioned above, there is a need for regulating supply of water to prevent the water from being wasted. Further, there is a need for reducing damage caused to a building by flooding through plumbing fixtures. Furthermore, there is a need for preventing increased water bills and repair expenses. Still further, there is a need for maintaining supply of water for a desired amount of time.

### SUMMARY OF THE DISCLOSURE

In view of the foregoing disadvantages inherent in the prior art, the general purpose of the present disclosure is to provide a safety valve system, that is configured to include all the advantages of the prior art, and to overcome the drawbacks inherent therein.

Accordingly, an object of the present disclosure is to provide a safety valve system for regulating a supply of water through a water supply line.

Further, another object of the present disclosure is to provide a safety valve system for preventing damage caused by flooding.

Yet another object of the present disclosure is to provide a safety valve system that prevents increased water bill expenses by regulating a supply of water.

Still another object of the present disclosure is to provide a safety valve system for maintaining a supply of water through a water supply line for a desired amount of time.

In light of the above objects, in one aspect of the present disclosure, a safety valve system for regulating supply of water through a water supply line, is provided. The safety valve system includes a shut-off valve, a flow indicator and a control panel. The shut-off valve is coupled with the water supply line. Further, the shut-off valve is configured to assume one of an open position and a closed position. The shut-off valve is communicably coupled to the flow indicator. The flow indicator includes a timer. The timer is capable of being activated for a pre-determined time. The timer is activated when the water starts flowing through the water supply line. The flow indicator is communicably coupled to the control panel. The control panel includes a plurality of switches for controlling at least one of the timer and the shut-off valve. The open position of the shut-off valve allows the water to flow through the water supply line and the closed position of the shut-off valve stops the flow of the water. The shut-off valve assumes the closed position upon the elapsing of the pre-determined time on the timer, thereby regulating the supply of the water through the water supply line.

Herein, the shut-off valve stops the flow of the water when the pre-determined time elapses. Accordingly, the water may flow through the water supply line for the pre-determined time prior to activation of the shut-off valve.

This together with other aspects of the present disclosure, along with the various features of novelty that characterize the present disclosure, is pointed out with particularity in the claims annexed hereto and forms a part of this present disclosure. For a better understanding of the present disclosure, its operating advantages, and the specific objects attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates a block diagram of a safety valve system, according to an embodiment of the present disclosure;

FIG. 2A illustrates an exemplary installation of a safety valve system, according to an embodiment of the present disclosure; and

FIG. 2B illustrates an exemplary exploded view of a shut-off valve of the safety valve system of FIG. 2, according to an embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in composition, structure, and design. It should be emphasized, however, that the present disclosure is not limited to safety valve systems, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms, “first,” “second,” and the like, herein do not denote any order, or importance, but rather are used to distinguish one element over another. The terms “a” and “an” herein do not denote a limitation of quantity, but rather denote the presence of at least one of the referenced items.

The present disclosure provides a safety valve system for regulating supply of water through a water supply line. The safety valve system includes a shut-off valve, a flow indicator and a control panel. The supply of the water may be regulated based on a pre-determined time set for the safety valve system. A timer included in the flow indicator of the safety valve system may be activated when the water starts flowing in the water supply line. The safety valve system may allow for continuous flow of the water for a duration of the pre-determined time. Upon elapsing of the pre-determined time, the flow of the water may be shut off by activating the shut-off valve of the safety valve system. The safety valve system may be switched off when water supply is required for long durations. The safety valve system may be installed with the water supply line. Further, it will be apparent to a person skilled in the art that the safety valve system may be installed in any other portion of a water distribution system.

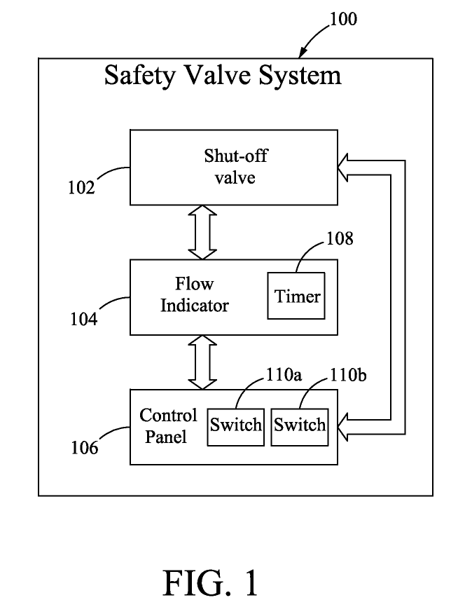

Referring now to FIG. 1, a block diagram of a safety valve system 100 is shown, according to an embodiment of the present disclosure. The safety valve system 100 includes a shut-off valve 102, a flow indicator 104 and a control panel 106.

The shut-off valve 102 is coupled with a water supply line (not shown). Further, the shut-off valve 102 is configured to assume one of an open position (not shown) and a closed position (not shown). The shut-off valve 102 is communicably coupled to the flow indicator 104. The flow indicator 104 includes a timer 108. The timer 108 is capable of being activated for a pre-determined time. The timer 108 is activated when the water starts flowing through the water supply line. The flow indicator 104 is communicably coupled to the control panel 106. The control panel 106 includes a plurality of switches, such as a switch 110a and a switch 110b, for controlling at least one of the timer 108 and the shut-off valve 102. The open position of the shut-off valve 102 allows the water to flow through the water supply line and the closed position of the shut-off valve 102 stops the flow of the water. The shut-off valve 102 assumes the closed position on elapsing of the pre-determined time on the timer 108, thereby regulating the supply of the water through the water supply line.

For the purpose of description of the present disclosure, the shut-off valve 102 may be an electronic valve. Further, the pre-determined time may indicate a time for which the water may flow through the water supply line, once the timer 108 has been activated. Activation of the timer 108 implies that the pre-determined time is being clocked by the timer 108. The pre-determined time may be set by a user of the safety valve system 100.

In an embodiment of the present disclosure, the timer 108 may include a display (not shown) for displaying readings of the timer 108. The display of the timer 108 may display a counter (not shown) that depicts one of elapsed time of the pre-determined time and remaining time of the pre-determined time. The timer 108 may activate when the flow of the water through the water supply line is detected. The flow indicator 104 may include one or more sensors (not shown) to detect the flow of the water through the water supply line. The flow indicator 104 may activate the timer 108 when the flow of the water starts. Upon clocking the pre-determined time on the timer 108, an electronic signal may be transmitted to the shut-off valve 102 for activating the shut-off valve 102. The shut-off valve 102 may be configured to assume the closed position when activated. In the closed position, the shut-off valve 102 may stop the flow of the water through the water supply line. The timer 108 may deactivate when the pre-determined time is clocked on the timer 108. Further, the shut-off valve 102 may deactivate after assuming the closed position.

In another case, the timer 108 may be deactivated when the water stops flowing through the water supply line before elapsing of the pre-determined time on the timer 108. Accordingly, the shut-off valve 102 remains in the open position when the pre-determined time has not elapsed on the timer 108 of the flow indicator 104.

Thereafter, the timer 108 may be reset and reactivated for the pre-determined time when the water starts flowing through the water supply line. For example, the pre-determined time may be one hour and the flow of the water may stop after half an hour. Since the pre-determined time of one hour has not elapsed, the timer 108 may be deactivated and reset. The timer 108 may reactivate when the water starts flowing through the water supply line. The timer 108 and the shut-off valve 102 may be supplied power through the control panel 106 for regulating the flow of the water.

The control panel 106 includes the plurality of switches to control at least the timer 108 and the shut-off valve 102. The switch 110a may be an ON-OFF switch (hereinafter referred to as ‘ON-OFF switch 110a’) and the switch 110b may be a reset switch 110b (hereinafter referred to as ‘reset switch 110b’). The ON-OFF switch 110a may be capable of assuming one of an ON position (not shown) and an OFF position (not shown). The ON-OFF switch 110a may assume the ON position when the user switches on the ON-OFF switch 110a. Similarly, the ON-OFF switch 110a may assume the OFF position when the user switches off the ON-OFF switch 110a. In the ON position of the ON-OFF switch 110a, the power may be supplied to the safety valve system 100 to operate the timer 108 and the shut-off valve 102. In the ON position, the safety valve system 100 is activated. Activation of the safety valve system 100 indicates that the safety valve system 100 is enabled to regulate the flow of the water.

Further, the OFF position of the ON-OFF switch 110a may deactivate the safety valve system 100. Accordingly, in the OFF position, the power may not be supplied to the timer 108 and the shut-off valve 102 for regulating the supply of the water in the water supply line. The OFF position of the ON-OFF switch 110a may allow for longer usage of the water, such as while watering plants.

The reset switch 110b of the control panel 106 may reactivate the safety valve system 100. Specifically, the reset switch 110b may reactivate the timer 108 and enable the flow of the water through the water supply line by signaling the shut-off valve 102 to assume the open position. In an embodiment of the present disclosure, the control panel 106 may transmit a signal to the shut-off valve 102 to activate the shut-off valve for assuming the open position. After the assuming the open position, the shut-off valve 102 may deactivate again. As mentioned previously, the timer 108 deactivates when the water flows for the pre-determined time. Upon elapsing of the pre-determined time on the timer 108, the shut-off valve 102 is activated to assume the closed position for blocking the flow of the water through the water supply line. Thereafter, the shut-off valve 102 is deactivated in the closed position, and the shut-off valve 102 continues to block the flow of the water. The reset switch 110b may be pressed by the user to activate the shut-off valve 102, so that the shut-off valve 102 may assume the open position. Thereafter, the shut-off valve 102 is deactivated in the open position, and the shut-off valve 102 continues to allow the flow of the water. Further, the timer 108 may be reset. The timer 108 may reactivate when the water starts flowing through the water supply line.

In one embodiment of the present disclosure, the control panel 106 may have a length dimension of about 3 inches, a breadth dimension of about 4 inches and a height dimension of about 1 inch. Further, the shut-off valve 102 may have a length dimension of about 6 inches and each of a breadth dimension and a height dimension of the shut-off valve 102 may be about 3 inches.

It will be evident to those skilled in the art that the safety valve system 100 may include various hardware components such as a power supply, cables, and the like, for providing power and enabling communication between the shut-off valve 102, the flow indicator 104 and the control panel 106. Further, nuts and bolts (not shown) may be employed for assembling and installing the safety valve system 100 in the water supply line.

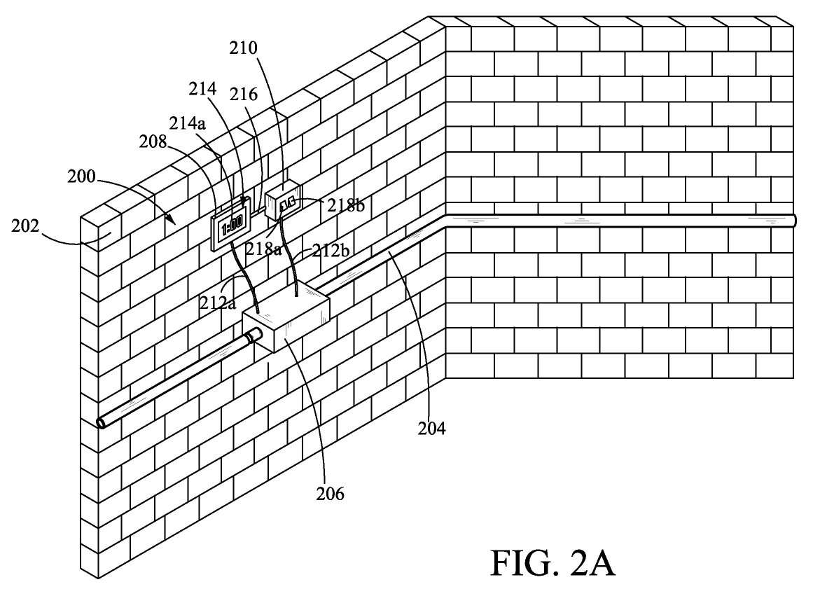

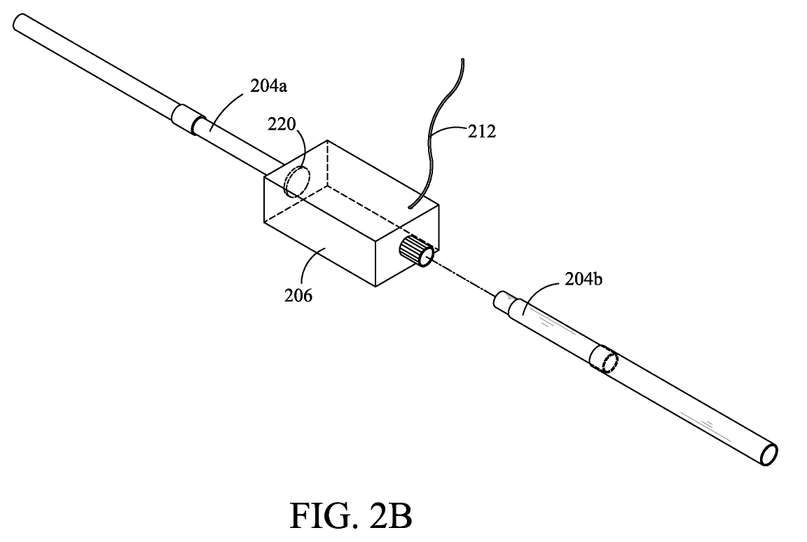

The safety valve system 100 may be installed in buildings, such as commercial and residential buildings, for regulating the supply of the water through the water supply line. The safety valve system 100 is explained in more detail in conjunction with FIGS. 2A and 2B.

Referring now to FIG. 2A, an exemplary installation of a safety valve system 200 (similar to the safety valve system 100 of FIG. 1), according to an embodiment of the present disclosure is shown.

FIG. 2A depicts a wall 202 of a building, such as a commercial building, where the safety valve system 200 may be installed. Specifically, FIG. 2A depicts a water supply line 204 through which the flow of the water is to be regulated. Further, FIG. 2A depicts a shut-off valve 206 (similar in operation and features to the shut-off valve 102), a flow indicator 208 (similar in operation and features to the flow indicator 104) and a control panel 210 (similar in operation and features to the control panel 106). Furthermore, FIG. 2A depicts a first wire 212a, a second wire 212b and a timer 214 (similar in operation and features to the timer 108). Hereinafter, the first wire 212a and the second wire 212b may collectively be referred to as ‘wiring system 212’. Examples of the wiring system 212 may include, but are not restricted to low voltage lines. The wiring system 212 may enable communication between the shut-off valve 206, the flow indicator 208 and the control panel 210.

It will be apparent to a person skilled in the art that the water may be provided in the building through the water supply line 204. In order to regulate the supply of the water through the water supply line 204, the shut-off valve 206 may be coupled with the water supply line 204 (as shown). In an embodiment of the present disclosure, the water supply line 204 may include threads (not shown) at center portions (not shown) of the water supply line 204. The shut-off valve 206 may include a corresponding arrangement to couple with the threads of the center portions of the water supply line 204. It will be apparent to a person skilled in the art that other similar male and female connectors may be utilized for coupling the shut-off valve 206 with the water supply line 204.

The shut-off valve 206 is coupled to the flow indicator 208 and the control panel 210 through the first wire 212a and the second wire 212b, respectively. The flow indicator 208 includes the timer 214 that may be activated for a pre-determined time. The timer 214 may include a timer circuitry (not shown) and a display 214a. The display 214a may represent the pre-determined time being clocked thereon. In one embodiment of the present disclosure, the display 214a represents a counter for one of counting up remaining time of the pre-determined time and counting down elapsed time of the pre-determined time. The timer circuitry of the flow indicator 208 may clock the pre-determined time.

Further, the flow indicator 208 may include one or more sensors (not shown) to sense the flow of the water through the water supply line 204. Accordingly, the one or more sensors may be present in the shut-off valve 206. The one or more sensors may be coupled with the timer circuitry of the timer 214. In an embodiment of the present disclosure, the one or more sensors may signal the timer 214 to deactivate when the flow of the water stops within the pre-determined time.

In an embodiment of the present disclosure, the shut-off valve 206 may be activated or deactivated through the control panel 210. The control panel 210 may control at least one of the timer 214 and the shut-off valve 206. Further, the control panel 210 may be coupled to the flow indicator 208 through a cable, such as a cable 216. The control panel 210 includes a plurality of switches, such as an ON-OFF switch 218a (similar in functionality and features to the ON-OFF switch 110a) and a reset switch 218b (similar in functionality and features to the reset switch 110b) for controlling at least one of the timer 214 and the shut-off valve 206. The plurality of switches may be controlled by the user of the safety valve system 200. The safety valve system 200 may receive power when the ON-OFF switch 218a is in the ON position. The safety valve system 200 may not receive the power when the ON-OFF switch 218a is in the OFF position.

Specifically, the OFF position of the ON-OFF switch 218a may deactivate the timer 214 and the shut-off valve 206. Accordingly, the OFF position of the ON-OFF switch 218a may allow a longer use of the water, such as for watering a lawn.

The reset switch 218b may reactivate the timer 214 when the safety valve system 200 is activated, i.e. when the ON-OFF switch 218a is in the ON position. Further, the reset switch 218b may be operated for reactivating the timer 208 and to re-enable the flow of the water through the water supply line 204 by signaling the shut-off valve 206 to assume the open position. As mentioned previously, the timer 208 gets deactivated and the shut-off valve 206 assumes the closed position upon elapsing of the pre-determined time. The timer 214 may remain deactivated until the user presses the reset switch 218b. Accordingly, the flow of the water may remain blocked until the reset switch 218b is pressed by the user.

FIG. 2A illustrates the control panel 210 and the display 214a installed closer to the water supply line 204. However, it will be apparent to a person skilled in the art that the control panel 210 and the display 214a may be installed at a convenient location within the building that may be accessible to the user of the safety valve system 200.

Referring to FIG. 2B, an exemplary exploded view of the shut-off valve 206 of the safety valve system 200 is shown, according to an embodiment of the present disclosure. A transparent view of the shut-off valve 206 is shown to clearly depict an operation of the shut-off valve 206.

The shut-off valve 206 is coupled between a first center portion 204a and a second center portion 204b of the water supply line 204, as shown in FIG. 2B. Further, the shut-off valve 206 may be connected to the flow indicator 208 (not shown), and the control panel 210 (not shown) through the wiring system 212. The wiring system 212 includes the first wire 212a and the second wire 212b.

The shut-off valve 206 includes a water blocking member 220 (hereinafter referred to as “blocking member 220”) as depicted in FIG. 2B. The blocking member 220 may be utilized to block the flow of the water from the water supply line 204. In an embodiment of the present disclosure, the water may flow through the first center portion 204a to the second center portion 204b of the water supply line 204. Further, the water may flow into a building through the second center portion 204b. The blocking member 220 of the shut-off valve 206 may stop the water from flowing to the first center portion 204a when the shut-off valve 206 is in the closed position.

It will be apparent to a person skilled in the art that exact dimensions, materials used for construction, and operations of a safety valve system, such as the safety valve system 100 and the safety valve system 200, may vary based upon manufacturing of the same. Further, various other components, such as bolts, cables, connectors, and the like, may be utilized for the installation of the safety valve system. Furthermore, various components of the safety valve system may be assembled in various ways to make the safety valve system operable without deviating from the scope of the present disclosure.

As described above, the present disclosure describes a safety valve system, such as a safety valve system 100 and a safety valve system 200. The various embodiments of the safety valve system may be utilized for regulating the supply of the water through a water supply line, such as the water supply line 204. The safety valve system may enable a user to prevent waste of the water and may assist the user in controlling his/her water usage. Further, the safety valve system may help prevent damage that may be caused to furniture and equipment in a building, such as a house, due to flooding. Furthermore, the safety valve system may help the user to avoid increased water bills.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A safety valve system for regulating supply of water through a water supply line, the safety valve system comprising:
a shut-off valve coupled with the water supply line, the shut-off valve configured to assume one of an open position and a closed position;
a flow indicator communicably coupled to the shut-off valve, the flow indicator comprising a timer, the timer capable of being activated for a pre-determined time, the timer activated when the water starts flowing through the water supply line; and
a control panel communicably coupled to the flow indicator, the control panel comprising a plurality of switches for controlling at least one of the timer and the shut-off valve,
wherein the open position of the shut-off valve allows the water to flow through the water supply line and the closed position of the shut-off valve stops the flow of the water, and
wherein the shut-off valve assumes the closed position on elapsing of the pre-determined time on the timer, thereby regulating the supply of the water through the water supply line.

2. The safety valve system of claim 1, wherein the flow indicator is capable of deactivating the timer when the flow of the water from the water supply line stops within the pre-determined time.

3. The safety valve system of claim 1, wherein the plurality of switches comprises an ON-OFF switch, the ON-OFF switch capable of being in one of an ON position and an OFF position, wherein switching the ON-OFF switch in the ON position activates the safety valve system and wherein switching the ON-OFF switch in the OFF position deactivates the safety valve system.

4. The safety valve system of claim 1, wherein the plurality of switches comprises a reset switch, the reset switch capable of being operated for reactivating the timer upon elapsing of the pre-determined time on the timer.

5. The safety valve system of claim 1, wherein a length dimension of the shut-off valve is about 6 inches and each of a breadth dimension and a height dimension of the shut-off valve is about 3 inches.

6. The safety valve system of claim 1, wherein a length dimension of the control panel is about 3 inches, a breadth dimension of the control panel is about 4 inches and a height dimension of the control panel is about 1 inch.
